(19) United States
(12) Patent Application Publication
(10) Pub. No.: US 2007/0164051 A1
(43) Pub. Date: Jul. 19, 2007

(54) Device for dispensing liquid drops

(76) Inventors: Jan W. M. Mijers, Heemstede (NL); Brendan Hogan, Gort (IE)

Correspondence Address: BRINKS HOFER GILSON & LIONE, P.O. BOX 10395, CHICAGO, IL, 60610, US

(21) Appl. No.: 11/643,325

(22) Filed: Dec. 20, 2006

Related U.S. Application Data
(63) Continuation of application No. PCT/EP05/06642, filed on Jun. 20, 2005.

(30) Foreign Application Priority Data
Jun. 21, 2004 (DE) DE 202004009721.4

(51) Int. Cl. B67D 5/58; B65D 47/18

(52) U.S. Cl. 222/189.06; 222/420; 222/189.09

(57) ABSTRACT

A device for dispensing liquids in drop form is provided, including a dropper tip, a liquophilic membrane positioned within the dropper tip to substantially prevent contaminants from entering the dropper tip, and a liquophobic membrane positioned within the dropper tip, wherein the liquophobic membrane is substantially impervious to liquid and is generally pervious to air. The dropper tip defines an entry channel, a first passage defining a liquid outlet flow path for fluid to exit the dropper tip, and a second passage defining an air inlet flow path for fluid to enter the dropper tip. The liquophilic membrane is positioned between the entry channel and the first passage to substantially prevent contaminants from entering the entry channel via the first passage, and the liquophobic membrane is positioned between the entry channel and the second passage.

### CROSS-REFERENCE TO RELATED APPLICATION

This patent application is a continuation of International Application PCT/EP2005/006642 published as PCT patent application WO 2005/123528 A1, with an international filing date of Jun. 20, 2005 and entitled “DEVICE FOR DISPENSING LIQUIDS IN THE FORM OF DROPS,” which claims the benefit of priority to German patent application DE 20 2004 009 721.4, filed Jun. 21, 2004 and entitled “Vorrichtung Zur Abgabe Von Flüssigkeiten in Form Von Tropfen,” the entire contents of each of which are incorporated herein by reference.

### FIELD OF THE INVENTION

This invention relates to a device for dispensing liquid drops such as an eye dropper.

### BACKGROUND

A dropper is a device for dispensing liquid in relatively small quantities, such as liquid drops. One particularly suitable application for a dropper is for dispensing medications into a patient's eye or for dispensing small quantities of a liquid ingredient for a liquid mixture or solution. It is often desirable for a dropper to dispense liquid drops of a consistent and accurate volume.

Patent Number EP 0 401 022 B1 discloses a dropper device generally used in the field of ophthalmology for administering eye drops. The dropper typically includes or is connected to a container for storing liquid to be dispensed from the dropper. The container is often generally elastic, or at least includes an elastic area, so that the user is able to exert pressure on the container and cause liquid to be dispensed from the dropper. Specifically, the user causes an increase in pressure in the dropper and causes a liquid drop to exit the tip of the dropper. Then, when the user releases the container, air is drawn into the dropper so as to maintain a generally constant fluid volume therewithin.

In the device identified in Patent Number EP 0 401 022 B1, a single passage is used for dispensing the liquid and for the ingress of air into the container. A composite membrane, including a liquophilic and a liquophobic section, is positioned across the single passage. The liquophilic and liquophobic sections cooperate to meter the liquid dispensed in drop form from the device. Specifically, the metering rate is affected by the surface area and the pore size of the liquophilic portion of the composite membrane. Therefore, the composite membrane is designed to avoid simultaneously a stream from emerging from the dropper tip. However, this metering design may be difficult to achieve and may not be accurate due to the composite nature of the membrane. Additionally, this design requires inlet air to flow into the container along the same path as the dispensed liquid in the opposite direction, thereby potentially disrupting the flow of the dispensed liquid.

It is therefore desirable to provide a device for dispensing liquid drops having a relatively simple, accurate, and reliable mechanism for metering the liquid drops dispensed therefrom and having a mechanism that permits the flow of inlet air without disrupting the flow of the dispensed liquid.

### BRIEF SUMMARY

In one aspect, a device for dispensing liquids in drop form is provided, including a dropper tip, a liquophilic membrane positioned within the dropper tip to substantially prevent contaminants from entering the dropper tip, and a liquophobic membrane positioned within the dropper tip, wherein the liquophobic membrane is substantially impervious to liquid and is generally pervious to air. The dropper tip defines an entry channel, a first passage defining a liquid outlet flow path for fluid to exit the dropper tip, and a second passage defining an air inlet flow path for fluid to enter the dropper tip. The liquophilic membrane is positioned between the entry channel and the first passage to substantially prevent contaminants from entering the entry channel via the first passage, and the liquophobic membrane is positioned between the entry channel and the second passage. The device avoids the problems of the above-described prior art by preventing a stream of inlet air from moving along the same path in an opposite direction as the dispensing flow of liquid. Additionally, by designing the second passage to have desired dimensions, the ingress of air is able to be precisely controlled because the size of the drop is typically directly related to the ingress of air.

In another aspect, the liquophilic membrane is a micro-porous, liquophilic membrane and the liquophobic membrane is a micro-porous, liquophobic membrane. The first and second passages may be fluidly separated from each other by the liquophilic membrane, the entry channel, and the liquophobic membrane. The liquophobic membrane may be completely impervious to liquid such that liquid in the entry channel is unable to enter the second passage.

In yet another aspect, the second passage includes a bore configured to regulate the air flow along the air inlet flow path and permit the fluid to exit the dropper tip in substantially uniform-sized drops. In an alternative aspect, the second passage includes a slot configured to regulate the air flow along the air inlet flow path and permit the fluid to exit the dropper tip in substantially uniform-sized drops.

In another aspect, the device includes a container connected to the dropper tip for supplying fluid to the entry channel.

In yet another aspect, the dropper tip includes a first housing component and a second housing component. The first and second housing components may each be formed by injection molding. The second housing component may define the first passage, the second passage, and an air channel extending between the entry channel and the liquophobic membrane. The first housing component may define the entry channel and may be configured to be connected to the container for supplying fluid to the entry channel.

The liquophobic membrane and the liquophilic membrane may each be secured between the first and second housing components. The second housing component may define a plurality of bearing surfaces for supporting the liquophilic membrane and the liquophobic membrane, respectively.

### BRIEF DESCRIPTION OF THE DRAWINGS

FIG. 1 is a partial-section, cross-sectional view of an embodiment.

### DETAILED DESCRIPTION OF THE DRAWINGS AND THE PRESENTLY PREFERRED EMBODIMENTS

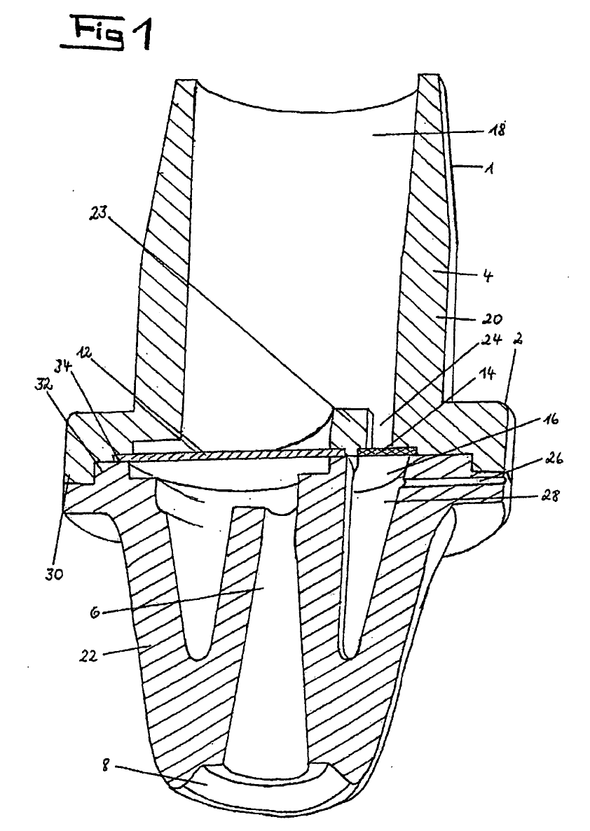

Referring now to preferred embodiments, FIG. 1 shows a device 1 for dispensing liquid in drop form. The device 1 includes a dropper tip 2 shown in a practical embodiment having a length of about 15 mm and a maximum width of about 10 mm.

The device 1 is coupled with the dropper tip 2 by a connection 4 that is connected with a container (not shown) such that the dropper tip 2 receives liquid from the container. The dropper tip 2 includes a passage 6 for dispensing liquid from an exit opening 8. A liquophilic, micro-porous membrane 12 is positioned along the flow path of the liquid between the connection 4 and the exit opening 5. The liquophilic membrane 12 includes pores sized to resist a passage of contaminants into the dropper tip 2.

An air entry is provided for delivering an inlet air flow to the dropper tip during or shortly after liquid exits the exit opening 8 so as to maintain a constant volume of fluid within the dropper tip. In other words, the volume of liquid dispensed from the container is substituted with a generally equal volume of inlet air. For example, as shown in the figure, a second passage 16 for the ingress of air is provided in the dropper tip 2 which is completely separate from the first passage 6 and which leads to the entry channel 18 in the connection 4.

A liquophobic, micro-porous membrane 14 having a suitable pore size is disposed across the flow path of the air. The liquophobic membrane 14 is designed to resist the passage of liquid and to permit the passage of air therethrough. For example, the liquophobic membrane 14 in the figure is positioned across the air inlet flow path and is separated from the liquophilic membrane 12 such that two separate flow paths are defined.

The first passage 6 for the liquid and the second passage 16 for the ingress of air are both connected with the entry channel 18 and are each separated therefrom by the respective membranes 12, 14.

The dropper tip 2 of the exemplary embodiment shown includes a first housing half 20 and a second housing half 22 which is connected with the first housing half 20. The liquophilic membrane 12 and the liquophobic membrane 14 are each positioned between the two housing halves 20 and 22. The two housing halves 20 and 22 may be produced by injection molding from suitable plastics.

The first housing half 20 defines the connection 4 and the entry channel 18 as well as an air channel 24 that is separated by a wall 23 in the entry channel 18. The second housing half 22 defines the first passage 6 with the exit opening 8 for the liquid and the second passage 16 for the ingress of air.

As shown in the figure, the second passage 16 may be a bore 26 extending laterally to the outside of the second housing half 22. The bore 26 opens into a chamber 28 below the liquophobic membrane 14. Alternatively, the bore 26 may be a slot or the like.

The liquophilic membrane 12 is clamped between the two housing halves 20, 22 or can be connected with the first or second housing halves 20, 22 during and injection molding process. More specifically, the liquophilic membrane 12 may be inserted into the mold during molding of the first or second housing half 20, 22. In the exemplary embodiment shown the liquophilic membrane 12 is joined in this way with the upper first housing half 20.

The liquophobic membrane 14 may also be joined with the respectively produced housing halves during an injection molding process. More specifically, the liquophobic membrane 14 may be inserted into the mold during molding of the first or second housing half 20, 22. In the exemplary embodiment shown the liquophobic membrane 14 is joined in this way with the upper first housing half 20.

The two housing halves of the dropper tip 2 are preferably joined by ultrasonic welding. The first housing half 20 includes an outer annular projection 30 and the second housing half 22 includes an inner annular projection 32. The two housing halves 20 and 22 may be joined by intermeshing the annular projections 30 and 32 before a step of ultrasonic welding.

As also shown in the figure, a portion of the inner annular projection 32 of the second housing half 22 defines a bearing surface 34 for the membranes 12 and 14.

In one preferred embodiment that is not to be construed as limiting the scope of the invention, the housing halves 20, 22 are each made of one or more of the following materials: polypropylene, high density polyethylene, nylon 6, polyacetal, and polycarbonate. Additionally, in this preferred embodiment, the liquophilic membrane 12 includes pores having a pore size rating of about 0.2 micrometers (μm) and is made of one or more of the following materials: polysulphone membrane, cellulose acetate membrane, and cellulose proprionate membrane. Furthermore, in this preferred embodiment, the liquophobic membrane 14 includes pores having a pore size rating of about 0.2 micrometers (μm) and is made of one or more of the following materials: hydrophobic coated acrylic membrane and polytetrafluorethylene membrane on different backing layers.

It is therefore intended that the foregoing detailed description be regarded as illustrative rather than limiting, and that it be understood that it is the following claims, including all equivalents, are intended to define the spirit and scope of this invention. More particularly, the apparatus and assembly described are merely an exemplary apparatus and assembly, and they are not intended to be limiting. Many of the steps and devices for performing the steps described above may be eliminated or replaced by alternative steps and devices.

What is claimed is:

1. A device for dispensing liquids in drop form, comprising
a dropper tip defining an entry channel, a first passage defining a liquid outlet flow path for fluid to exit the dropper tip, and a second passage defining an air inlet flow path for fluid to enter the dropper tip;
a liquophilic membrane positioned within the dropper tip between the entry channel and the first passage to substantially prevent contaminants from entering the entry channel via the first passage; and
a liquophobic membrane positioned within the dropper tip between the entry channel and the second passage, wherein the liquophobic membrane is substantially impervious to liquid and is generally pervious to air.

2. A device as in claim 1, wherein the liquophilic membrane is a micro-porous, liquophilic membrane to substantially prevent contaminants from entering the entry channel via the first passage.

3. A device as in claim 2, wherein the liquophobic membrane is a micro-porous, liquophobic membrane to substantially prevent contaminants from entering the entry channel via the second passage.

4. A device as in claim 1, wherein the first and second passages are fluidly separated from each other by the liquophilic membrane, the entry channel, and the liquophobic membrane.

5. A device as in claim 4, wherein the liquophobic membrane is completely impervious to liquid such that liquid in the entry channel is unable to enter the second passage.

6. A device as in claim 1, wherein the second passage includes a bore configured to regulate the air flow along the air inlet flow path and permit the fluid to exit the dropper tip in substantially uniform-sized drops.

7. A device as in claim 1, wherein the second passage includes a slot configured to regulate the air flow along the air inlet flow path and permit the fluid to exit the dropper tip in substantially uniform-sized drops.

8. A device as in claim 1, further comprising a container connected to the dropper tip for supplying fluid to the entry channel.

9. A device as in claim 1, wherein the dropper tip includes a first housing component and a second housing component.

10. A device as in claim 9, wherein the first and second housing components are each formed by injection molding.

11. A device as in claim 9, wherein the second housing component defines the first passage and the second passage.

12. A device as in claim 11, wherein the second housing defines an air channel extending between the entry channel and the liquophobic membrane.

13. A device as in claim 12, wherein the first housing component defines the entry channel and is configured to be connected to a container for supplying fluid to the entry channel.

14. A device as in claim 9, wherein the liquophobic membrane is secured between the first and second housing components.

15. A device as in claim 14, wherein the liquophilic membrane is secured between the first and second housing components.

16. A device as in claim 15, wherein second housing component defines a plurality of bearing surfaces for supporting the liquophilic membrane and the liquophobic membrane, respectively.

17. A device as in claim 9, wherein the first and second housing components are connected with each other by interengaging inner and outer annular projections.

18. A device as in claim 17, wherein the first and second housing components are further connected with each other by ultrasonic welding.

19. A device as in claim 1, wherein the liquophilic membrane is made of one or more of the following materials: polysulphone, cellulose acetate, and cellulose proprionate.

20. A device as in claim 19, wherein the liquophobic membrane is made of one or more of the following materials: hydrophobic coated acrylic and polytetrafluorethylene.
